(19) United States
(12) Patent Application Publication
(10) Pub. No.: US 2015/0220153 A1
(43) Pub. Date: Aug. 6, 2015

(54) GESTURE RECOGNITION SYSTEM WITH FINITE STATE MACHINE CONTROL OF CURSOR DETECTOR AND DYNAMIC GESTURE DETECTOR

(71) Applicant: LSI Corporation, San Jose, CA (US)

(72) Inventors: Pavel A. Aliseychik, Moscow (RU); Aleksey A. Letunovskiy, Moscow (RU); Ivan L. Mazurenko, Moscow (RU); Alexander A. Petyushko, Moscow (RU); Denis V. Zaytsev, Moscow (RU)

(21) Appl. No.: 14/358,358

(22) PCT Filed: Apr. 29, 2014
(86) PCT No.: PCT/US14/35838

§ 371 Date: May 15, 2014

(30) Foreign Application Priority Data
Oct. 25, 2013 (RU) 2013147803

(51) Int. Cl. G06F 3/01; G06K 9/00; G06F 3/033

(52) U.S. Cl. CPC G06F 3/017; G06F 3/033; G06K 9/00335

(57) ABSTRACT

An image processing system comprises an image processor having image processing circuitry and an associated memory. The image processor is configured to implement a gesture recognition system. The gesture recognition system comprises a cursor detector, a dynamic gesture detector, a static pose recognition module, and a finite state machine configured to control selectively enabling of the cursor detector, the dynamic gesture detector and the static pose recognition module. By way of example, the finite state machine includes a cursor detected state in which cursor location and tracking are applied responsive to detection of a cursor in a current frame, a dynamic gesture detected state in which dynamic gesture recognition is applied responsive to detection of a dynamic gesture in the current frame, and a static pose recognition state in which static pose recognition is applied responsive to failure to detect a cursor or a dynamic gesture in the current frame.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor having image processing circuitry and an associated memory. The image processor is configured to implement a gesture recognition system utilizing the image processing circuitry and the memory, with the gesture recognition system comprising a cursor detector, a dynamic gesture detector, a static pose recognition module, and a finite state machine configured to control selective enabling of the cursor detector, the dynamic gesture detector and the static pose recognition module.

By way of example only, the finite state machine has a plurality of states including a cursor detected state in which cursor location and tracking are applied responsive to detection of a cursor in a current frame, a dynamic gesture detected state in which dynamic gesture recognition is applied responsive to detection of a dynamic gesture in the current frame, and a static pose recognition state in which static pose recognition is applied responsive to failure to detect a cursor or a dynamic gesture in the current frame.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor implementing a gesture recognition process in an illustrative embodiment.

FIG. 2 shows a more detailed view of an exemplary gesture recognition system of the image processor of FIG. 1.

FIG. 3 illustrates an embodiment of a recognition subsystem of the gesture recognition system of FIG. 2 without a finite state machine and cursor and dynamic gesture detectors.

FIG. 4 illustrates an embodiment of a recognition subsystem of the gesture recognition system of FIG. 2 with a finite state machine and cursor and dynamic gesture detectors.

FIG. 5 shows a more detailed view of portions of the recognition subsystem in the FIG. 4 embodiment.

FIG. 6 shows an exemplary state update module for the finite state machine of the recognition subsystem in the FIG. 4 embodiment.

### DETAILED DESCRIPTION

Embodiments of the invention will be illustrated herein in conjunction with exemplary image processing systems that include image processors or other types of processing devices configured to perform gesture recognition. It should be understood, however, that embodiments of the invention are more generally applicable to any image processing system or associated device or technique that involves recognizing gestures in one or more images.

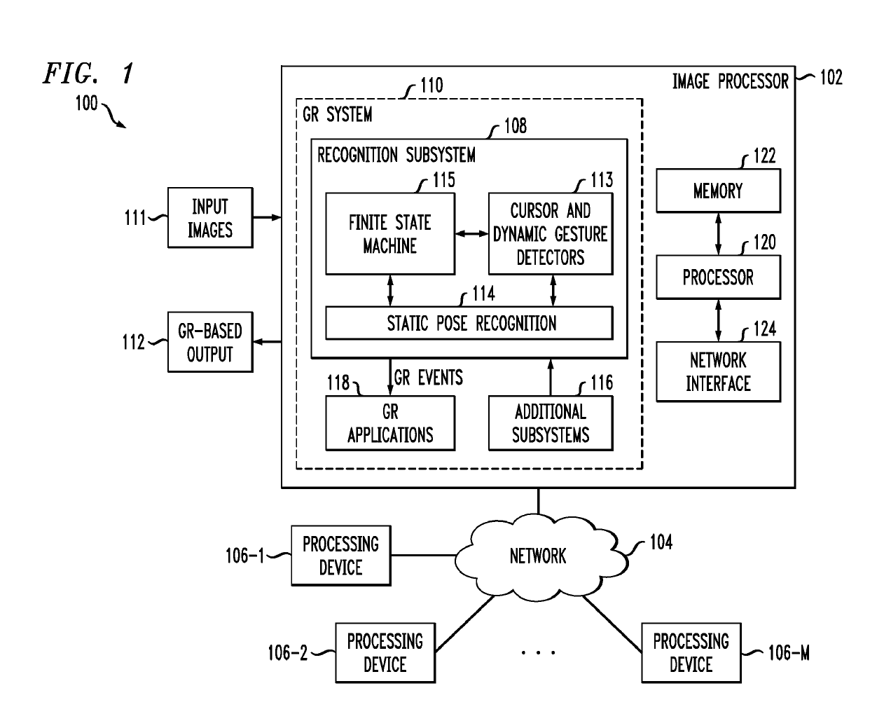

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a recognition subsystem 108 within a gesture recognition (GR) system 110. The GR system 110 in this embodiment processes input images 111 from one or more image sources and provides corresponding GR-based output 112. The GR-based output 112 may be supplied to one or more of the processing devices 106 or to other system components not specifically illustrated in this diagram.

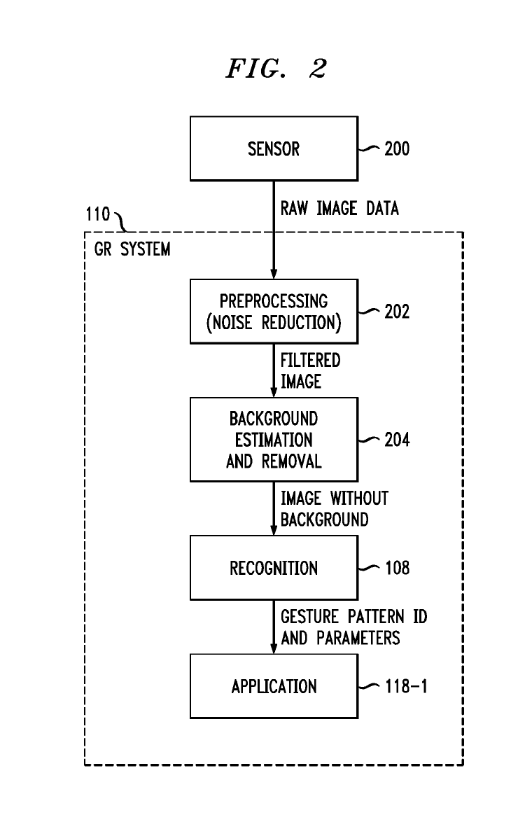

The recognition subsystem 108 of GR system 110 more particularly comprises cursor and dynamic gesture detectors 113, a static pose recognition module 114, and a finite state machine 115 configured to control selective enabling of the cursor detector, the dynamic gesture detector and the static pose recognition module. The operation of illustrative embodiments of the GR system 110 of image processor 102 will be described in greater detail below in conjunction with FIGS. 2 through 6.

The recognition subsystem 108 receives inputs from additional subsystems 116, which may comprise one or more image processing subsystems configured to implement functional blocks associated with gesture recognition in the GR system 110, such as, for example, functional blocks for input frame acquisition, noise reduction or other types of preprocessing, and background estimation and removal. It should be understood, however, that these particular functional blocks are exemplary only, and other embodiments of the invention can be configured using other arrangements of additional or alternative functional blocks.

In the FIG. 1 embodiment, the recognition subsystem 108 generates GR events for consumption by one or more of a set of GR applications 118. For example, the GR events may comprise information indicative of recognition of one or more particular gestures within one or more frames of the input images 111, such that a given OR application in the set of GR applications 118 can translate that information into a particular command or set of commands to be executed by that application.

Additionally or alternatively, the GR system 110 may provide GR events or other information, possibly generated by one or more of the GR applications 118, as GR-based output 112. Such output may be provided to one or more of the processing devices 106. In other embodiments, at least a portion of set of GR applications 118 is implemented at least in part on one or more of the processing devices 106.

Portions of the GR system 110 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of gestures within frames of an input image stream comprising the input images 111. Such processing layers may also be implemented in the form of respective subsystems of the GR system 110.

It should be noted, however, that embodiments of the invention are not limited to recognition of static or dynamic hand gestures, but can instead be adapted for use in a wide variety of other machine vision applications involving gesture recognition, and may comprise different numbers, types and arrangements of modules, subsystems, processing layers and associated functional blocks.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the applications 118 may be implemented on a different processing device than the subsystems 108 and 116, such as one of the processing devices 106.

Moreover, it is to be appreciated that the image processor 102 may itself comprise multiple distinct processing devices, such that different portions of the GR system 110 are implemented using two or more processing devices. The term “image processor” as used herein is intended to be broadly construed so as to encompass these and other arrangements.

The GR system 110 performs preprocessing operations on received input images 111 from one or more image sources. This received image data in the present embodiment is assumed to comprise raw image data received from a depth sensor, but other types of received image data may be processed in other embodiments. Such preprocessing operations may include noise reduction and background removal.

The raw image data received by the GR system 110 from the depth sensor may include a stream of frames comprising respective depth images, with each such depth image comprising a plurality of depth image pixels. For example, a given depth image D may be provided to the GR system 110 in the form of matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of GR-based output 112 to one or more image destinations. At least a subset of such image sources and image destinations may be implemented as least in part utilizing one or more of the processing devices 106.

Accordingly, at least a subset of the input images 111 may be provided to the image processor 102 over network 104 for processing from one or more of the processing devices 106. Similarly, processed images or other related GR-based output 112 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize hand gestures, although the disclosed techniques can be adapted in a straightforward manner for use with other types of gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 113, 114, 115, 116 and 118 of image processor 102. One possible example of image processing circuitry that may be used in one or more embodiments of the invention is an otherwise conventional graphics processor suitably reconfigured to perform functionality associated with one or more of the components 113, 114, 115, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 112 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as the subsystems 108 and 116 and the GR applications 118. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

The operation of the GR system 110 of image processor 102 will now be described in greater detail with reference to the diagrams of FIGS. 2 through 6.

It is assumed in these embodiments that the input images 111 received in the image processor 102 from an image source comprise input depth images each referred to as an input frame. As indicated above, this source may comprise a depth imager such as an SL or ToF camera comprising a depth image sensor. Other types of image sensors including, for example, grayscale image sensors, color image sensors or infrared image sensors, may be used in other embodiments. A given image sensor typically provides image data in the form of one or more rectangular matrices of real or integer numbers corresponding to respective input image pixels. These matrices can contain per-pixel information such as depth values and corresponding amplitude or intensity values. Other per-pixel information such as color, phase and validity may additionally or alternatively be provided.

Referring now to FIG. 2, an embodiment of the GR system 110 is shown in more detail. In this embodiment, the GR system 110 is configured to receive raw image data from an image sensor 200 and includes a preprocessing subsystem 202, a background estimation and removal subsystem 204, recognition subsystem 108 and an application 118-1. The image sensor 200 in this embodiment is assumed to comprise a variable frame rate image sensor, such as a ToF image sensor configured to operate at a variable frame rate. Other types of sources supporting variable frame rates can be used in other embodiments.

The preprocessing subsystem 202 is illustratively configured to perform filtering or other noise reduction operations on the raw image data received from the image sensor 200 in order to produce a filtered image for application to the background estimation and removal subsystem 204. Any of a wide variety of image noise reduction techniques can be utilized in the subsystem 202. For example, suitable techniques are described in PCT International Application PCT/US13/56937, filed on Aug. 28, 2013 and entitled “Image Processor With Edge-Preserving Noise Suppression Functionality,” which is commonly assigned herewith and incorporated by reference herein.

The subsystem 204 estimates and removes the image background to produce an image without background that is applied to the recognition subsystem 108. Again, various techniques can be used for this purpose including, for example, techniques described in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

The recognition subsystem 108 recognizes within the image a gesture from a specified gesture vocabulary and generates a corresponding gesture pattern identifier (ID) and possibly additional related parameters for delivery to the application 118-1. The configuration of such information is adapted in accordance with the specific needs of the application. As noted above, the application may be configured to translate the identified gesture to a command or set of commands.

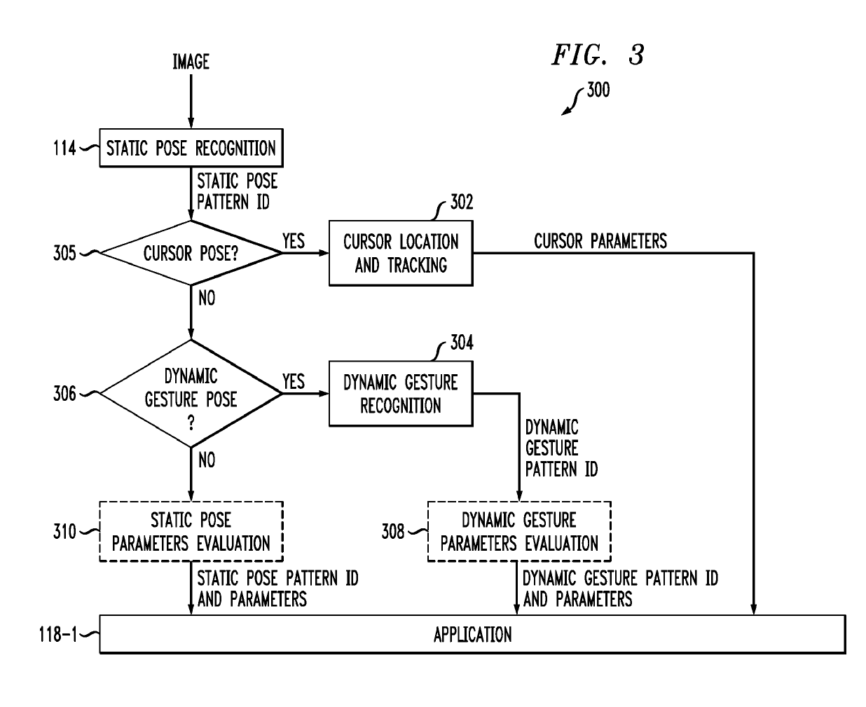

FIG. 3 illustrates an embodiment 300 of recognition subsystem 108 that does not include cursor and dynamic gesture detectors 113 and finite state machine 115. In this embodiment, the static pose recognition module 114 directly processes an input image to detect one of a plurality of predefined static poses. The predefined static poses can be separated into three groups as follows:

1. Cursor poses, including pointing finger or “fingergun” poses for short range applications, and pointing hand or other arm or body poses for long range applications.

2. Poses used for defining dynamic gestures. For example, palm poses may be used to define swipe gestures.

3. Poses defined as static gestures.

Groups 2 and 3 above may intersect, but the gesture vocabulary of the GR system 110 is typically configured to avoid such intersection. It should be noted that the cursor is considered a particular type of gesture used to indicate cursor position in the GR system. Accordingly, a cursor may also be referred to herein as a cursor gesture.

A dynamic gesture typically comprises a combination of one or more static poses and some associated movement. Examples of dynamic hand gestures include a swipe left gesture, a swipe right gesture, a swipe up gesture, a swipe down gesture, a poke gesture and a wave gesture, although various subsets of these dynamic gestures as well as additional or alternative dynamic gestures may be supported in other embodiments. Accordingly, embodiments of the invention are not limited to use with any particular gesture vocabulary. In the case of arm or body gestures, the one or more static poses and associated movement of a given dynamic gesture comprise respective static poses and associated movement of the arm or body.

In the FIG. 3 embodiment, the static pose recognition module 114 is configured to identify a particular pose in the input image. As indicated above, the pose may be a cursor pose, a dynamic gesture pose, or a pose defined as a static gesture. The output of the static pose recognition module 114 for a given input image in this embodiment comprises a static pose pattern ID, which identifies a particular pose. The output may additionally include static pose parameters generated by the static pose recognition module 114.

A determination is then made as to whether or not the static pose pattern ID corresponds to a cursor pose or a dynamic gesture pose in order to control application of cursor location and tracking block 302 or dynamic gesture recognition block 304 as appropriate. More particularly, decision block 305 determines if the pose identified in the input image is a cursor pose, and if the pose is a cursor pose, cursor location and tracking block 302 is applied to generate cursor parameters that arc provided to application 118-1. The cursor location and tracking block 302 is illustratively configured to determine coordinates of a cursor point within the image and to apply appropriate noise reduction filters, which may involve averaging cursor coordinates within a specified time period.

If the identified pose is not a cursor pose, decision block 306 determines if the identified pose is a dynamic gesture pose, and if the pose is a dynamic gesture pose, dynamic gesture recognition block 304 is applied to generate a dynamic gesture pattern ID that is provided to application 118-1, possibly in conjunction with parameters determined by optional dynamic gesture parameters evaluation block 308. By way of example, the parameters evaluation block 308 may be configured to include extended noise reduction filters in order to calculate a zoom factor parameter of a zoom gesture.

The dynamic gesture recognition block 304 calculates velocities of one or more parts of the image, based on movement of those parts over a specified period of time relative to their respective positions in one or more previous images of an image sequence. The calculated velocities are utilized in block 304 in combination with the static pose pattern ID and any associated parameters provided by the static pose recognition module 114 to recognize a particular gesture.

If the identified pose is not a cursor pose or a dynamic gesture pose, the identified pose is assumed to be a pose defined as a static gesture, and the static pose pattern ID is provided to application 118-1, possibly in conjunction with parameters determined by optional static pose parameters evaluation block 310.

In some implementations of the FIG. 3 embodiment, the parameters evaluation blocks 308 and 310 may be incorporated at least in part within the respective dynamic recognition block 304 and static pose recognition module 114. Such arrangements may be utilized, for example, if the associated parameters are part of a feature vector for a Gaussian Mixture Model (GMM) implemented in the recognition block or module.

In the FIG. 3 embodiment, the static pose recognition module 114 performs relatively complex and time-consuming operations as compared to other portions of the GR system 110 such as cursor location and tracking block 302 and dynamic gesture recognition block 304. For example, depending on factors such as the noise level, static pose definitions and required recognition precision, the static pose recognition module 114 may be configured to perform operations such as additional background evaluation and removal, region of interest (ROI) detection, morphological image processing, affine transformations such as shifting, rotating and zooming, and expectation maximization for GMMs. As a result, the static pose recognition module 114 when arranged with other system components as shown in FIG. 3 can create a significant bottleneck for the overall GR system 110. Such a bottleneck can make it difficult to achieve desired levels of recognition precision, particularly when processing an image stream from an image sensor in real time at high frame rates.

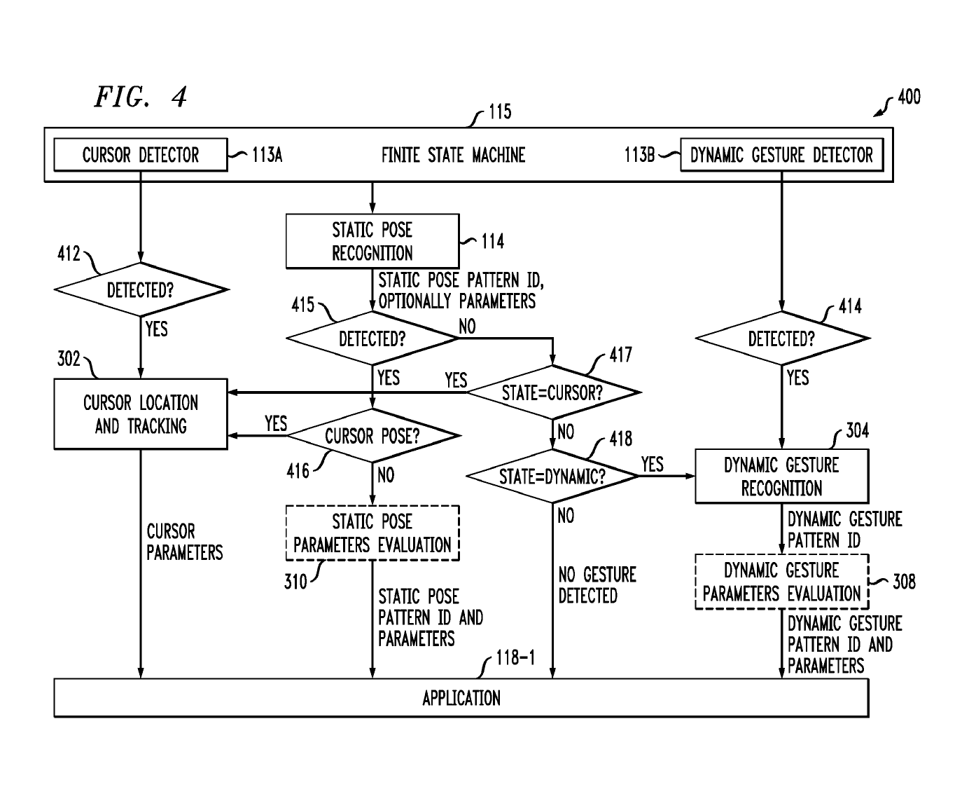

FIG. 4 illustrates an embodiment 400 of recognition subsystem 108 that includes cursor and dynamic gesture detectors 113 and finite state machine 115. The cursor detector and dynamic gesture detector are more specifically denoted in this embodiment by respective reference numerals 113A and 113B, and are illustratively shown as being implemented within the finite state machine or FSM 115. This embodiment also includes static pose recognition module 114, cursor location and tracking block 302, dynamic gesture recognition block 304, optional parameters evaluation blocks 308 and 310, and application 118-1.

This embodiment is an example of an arrangement in which the finite state machine 115 is configured to control selective enabling of the cursor detector 113A, the dynamic gesture detector 113B and the static pose recognition module 114. As a more particular example, the finite state machine 115 may be configured such that only one of the cursor detector 113A, dynamic gesture detector 113B and static pose recognition module 114 is enabled at a time. Other types of selective enabling of these components using different finite state machines may be used in other embodiments. Accordingly, the term “selective enabling” as used herein is intended to be broadly construed.

The finite state machine 115 in the present embodiment is illustratively configured to have a plurality of states including a cursor detected state in which the cursor location and tracking block 302 is applied responsive to detection of a cursor in a current frame, a dynamic gesture detected state in which dynamic gesture recognition block 304 is applied responsive to detection of a dynamic gesture in the current frame, and a static pose recognition state in which static pose recognition module 114 is applied responsive to failure to detect a cursor or a dynamic gesture in the current frame.

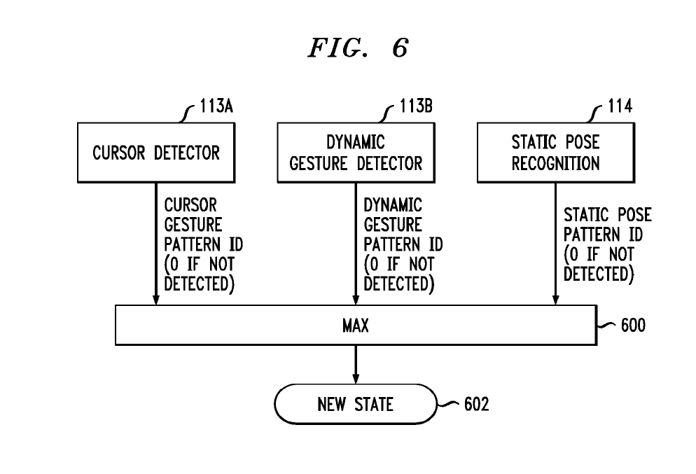

An initial state of the finite state machine 115 for the current frame is given by a final state of the finite state machine for a previous frame. Similarly, the final state of the finite state machine for the current frame is utilized as an initial state of the finite state machine for a subsequent frame. A final state of the finite state machine for a given frame is determined as a function of outputs of respective ones of the cursor detector 113A, dynamic gesture detector 113B and static pose recognition module 114 for that frame, as will be described in more detail below in conjunction with FIG. 6.

The embodiment of FIG. 4 is advantageously configured to eliminate the above-described potential bottleneck that can arise when the static pose recognition module 114 is arranged as shown in FIG. 3. More particularly, in the FIG. 4 embodiment, the finite state machine 115 controls selective enabling of the cursor detector 113A, dynamic gesture detector 113B and static pose recognition module 114 in a manner that allows the cursor detector 113A and the dynamic gesture detector 113B to operate at a higher frame rate than the static pose recognition module 114. As part of this exemplary selective enabling, the finite state machine can adjust a frame rate of operation of the recognition subsystem 108 of GR system 110 responsive to outputs of the cursor detector 113A and the dynamic gesture detector 113B. This facilitates the processing of an image stream in real time at high frame rates, allowing higher levels of recognition precision to be achieved relative to the FIG. 3 embodiment.

For example, the FIG. 4 embodiment allows a cursor and dynamic gestures to be recognized and evaluated using relatively short computation times and therefore relatively high frame rates, on the order of 90 frames per second or more, while static gestures are recognized and evaluated using relatively long computation times and therefore relatively low frame rates, on the order of about 30 frames per second. As mentioned previously, use of such variable frame rates is supported by an image sensor that can operate at variable frame rates, such as the ToF image sensor assumed for the present embodiment.

Accordingly, the finite state machine 115 controls the cursor detector 113A, dynamic gesture detector 113B and static pose recognition module 114 such that higher frame rates are provided for more time-critical tasks such as those performed in cursor location and tracking block 302 and dynamic gesture recognition block 304, while lower frame rates are provided for less time-critical tasks such as those performed by static pose recognition module 114. The frame rate is dynamically varied at runtime depending upon whether the current frame is determined to contain a cursor, a dynamic gesture or a static gesture.

The dynamic variation of the frame rate at runtime can be achieved in the recognition subsystem 108 of GR system 110 by acquiring the next frame immediately when the current frame has been processed, rather than acquiring input frames at a fixed rate. Those frames processed through the cursor location and tracking block 302 or dynamic gesture recognition block 304 responsive to respective detection of a cursor or a dynamic gesture by detector 113A or 113B will be processed much more quickly than those frames in which a cursor or a dynamic gesture is not detected. Accordingly, the FIG. 4 embodiment permits faster processing of a current frame and faster acquisition of a subsequent frame upon detection of a cursor or a dynamic gesture in the current frame.

If the image sensor supplying input images to the image processor 102 does not support a variable frame rate, dynamic variation of the frame rate can still be achieved in the GR system 110 by, for example, skipping one or more input frames in order to emulate variable frame rate image sensor functionality.

It is also possible in a given embodiment that the cursor detector 113A, dynamic gesture detector 113B and static pose recognition module 114 each operate at a different frame rate. Additionally, other embodiments can be configured such that all three of these components operate at the same frame rate.

The recognition subsystem 108 in the FIG. 4 embodiment may be viewed as being separated into distinct portions for detection and processing of cursors, dynamic gestures and static gestures, respectively. Different combinations of hardware, software and firmware can be used for each of these portions. The finite state machine 115 in the present embodiment may be viewed as controlling selective enabling of the portions such only one of the portions is enabled at a time. Thus, references herein to selective enabling of cursor detector 113A, dynamic gesture detector 113B and static pose recognition module 114 should be broadly construed so as to encompass in some embodiments selective enabling of respective associated elements such as curser location and tracking block 302 for cursor detector 113A, dynamic gesture recognition block 304 and dynamic gesture parameters evaluation block 308 for dynamic gesture detector 113B, and static pose parameters evaluation block 310 for static pose recognition module 114.

The cursor detector 113A is configured to detect the presence of a cursor pose within the current frame. As noted above, a cursor pose may comprise a pointing finger pose or fingergun pose for short range applications, and pointing hand or other arm or body poses for long range applications. The cursor detector combines all other non-cursor poses into a single recognition class, illustratively denoted as an “other pose” class, which significantly reduces the number of classes from the eight or more used for respective static poses in a typical gesture vocabulary to two or three classes. Such an arrangement allows the use of efficient and time-saving recognition algorithms without affecting the recognition quality. For example, the cursor detector 113A can be implemented using relatively simple threshold logic by calculating the size of the hand nearest to a controlled device and comparing the calculated size to a specified threshold. If the hand size is below the threshold, it is recognized as a pointing finger or pointing hand, and the pose is recognized as a cursor pose. Numerous other implementations of the cursor detector module are possible.

The dynamic gesture detector 113B is configured to detect the presence of a dynamic gesture pose within the current frame. Again, all static poses that are not used to define dynamic gestures can be combined into a single recognition class in order to simplify the dynamic gesture detector. For example, the dynamic gesture detector can be configured to operate using four classes of static poses, namely, a palm class used for swipe gestures, a palm with fingers class, a palm with pinch class used for zoom gestures, and the “other pose” class. One possible implementation of the dynamic gesture detector in the present embodiment also utilizes relatively simple threshold logic by calculating velocities for parts of the image and comparing the calculated velocities to respective specified thresholds. If the calculated velocities exceed the thresholds, significant motion is detected and the detector determines that the gesture in the current frame is not static. This example assumes that the definition of a static gesture includes no significant motion.

In some embodiments, the dynamic gesture detector 113B may also be configured to perform dynamic gesture recognition. Accordingly, in these embodiments, the separate dynamic gesture recognition block can be eliminated.

It should be noted that various parameters computed by the cursor detector 113A or dynamic gesture detector 113B may be provided to the respective cursor location and tracking block 302 and dynamic gesture recognition block 304. For example, parameters such as finger coordinates and velocity computed by the cursor detector may be provided to the cursor location and tracking block 302 for application of averaging or other noise reduction operations. Also, some of the parameters computed by the cursor detector can be provided to the dynamic gesture detector, and vice versa. For example, an ROI mass center velocity computed by one of the detectors 113 may be re-used by the other.

Recognition subsystem components such as static pose recognition module 114, cursor location and tracking block 302, dynamic gesture recognition block 304 and parameters evaluation blocks 308 and 310 may be configured differently in the FIG. 4 embodiment than in the FIG. 3 embodiment, depending upon what parameters are computed by prior blocks or shared between blocks in the FIG. 4 embodiment.

The cursor detector 113A, dynamic gesture detector 113B and static pose recognition module 114 have associated therewith respective decision blocks 412, 414 and 415 which determine whether or not the corresponding cursor, dynamic gesture or static pose have been detected in the current frame. The decision blocks 412, 414 and 415, although shown in the figure as being separate from the respective cursor detector 113A, dynamic gesture detector 113B and static pose recognition module 114, can in other embodiments be incorporated within those respective elements.

The recognition subsystem 108 implements real time gesture recognition using a variable frame rate depending on the current state of the finite state machine 115 and the outputs of the decision blocks 412, 414 and 415. Additional decision blocks in the FIG. 4 embodiment include decision blocks 416, 417 and 418.

The outputs of the static pose recognition module 114, cursor location and tracking block 302, dynamic gesture recognition block 304, and parameters evaluation blocks 308 and 310 are generally consistent with their respective outputs as previously described in conjunction with the embodiment of FIG. 3. Thus, for example, static pose recognition module 114 when enabled generates a static pose pattern ID and optionally one or more associated parameters, cursor location and tracking block 302 when enabled generates cursor parameters, dynamic gesture recognition block 304 when enabled generates a dynamic gesture pattern ID, parameters evaluation block 308 when enabled generates parameters associated with the dynamic gesture pattern ID, and parameters evaluation block 310 when enabled generates additional parameters associated with the static pose pattern ID.

It is assumed that all of the cursor, dynamic gesture and static pose pattern IDs are different from one another, and that a zero pattern ID corresponds to an unrecognized gesture. The latter situation in FIG. 4 corresponds to a negative output from decision block 418 indicating that no gesture is detected in the current frame.

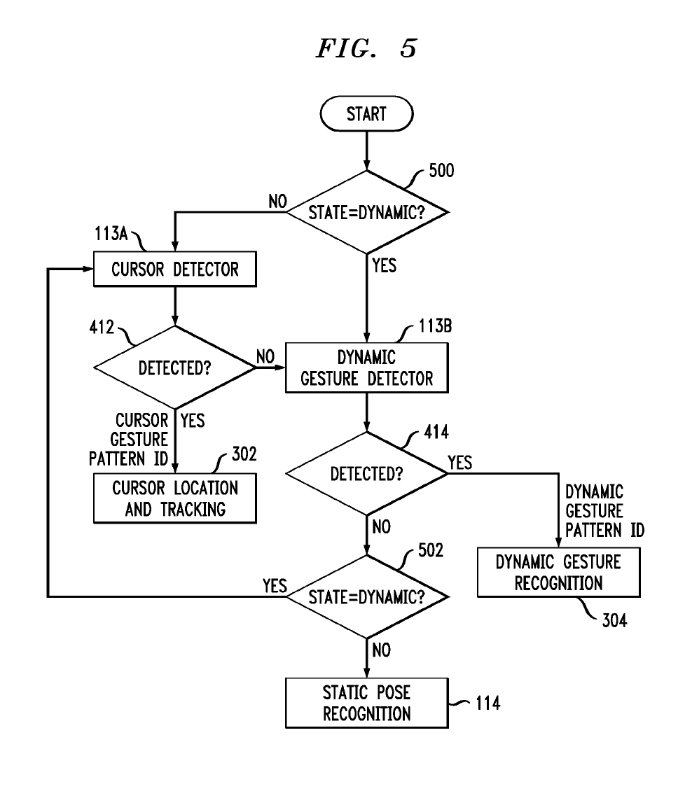

In the FIG. 4 embodiment, an affirmative output from decision block 412 or decision block 414 will lead to application of respective cursor location and tracking block 302 or dynamic gesture recognition block 304. Negative outputs from the decision blocks 412 and 414 are not explicitly shown in FIG. 4, but are processed in the manner indicated in FIG. 5. An affirmative output from decision block 415 will lead to decision block 416, which directs the process to the cursor location and tracking block 302 if the recognized static pose is a cursor pose, and otherwise directs the process to static pose parameters evaluation block 310. It is therefore possible for the static pose recognition module 114 to detect a cursor pose even if the cursor detector 113A did not detect a cursor pose in its initial detection iteration, due to additional image enhancements performed in the course of static pose recognition.

A negative output from decision block 415 will lead to decision block 417, which directs the process to the cursor location and tracking block 302 if the finite state machine 115 is still in a cursor detected state from a previous frame, and otherwise directs the process to decision block 418. An affirmative output from decision block 418 indicates that the finite state machine 115 is still in a dynamic gesture detected state from a previous frame, and the process is directed to the dynamic gesture recognition block 304. A negative output from decision block 418 indicates that no gesture has been detected in the current frame and this information is provided to application 118-1. The decision blocks 417 and 418 are therefore configured such that if no static pose is detected by the static pose recognition module 114, and the finite state machine is in either its cursor detected or dynamic gesture detected state, the decision is made using the finite state machine state. This additional correction significantly decreases the misdetection rate of the GR system.

FIG. 5 shows a more detailed view of the control functionality provided by finite state machine 115 in relation to cursor detector 113A and its associated blocks 412 and 302, dynamic gesture detector 113B and its associated blocks 414 and 304, and static pose recognition module 114. Additional decision blocks 500 and 502 are shown in FIG. 5 and are assumed to be present in the embodiment 400 but are omitted from FIG. 4 for simplicity and clarity of illustration.

If decision block 500 determines that an initial state of the finite state machine 115 for a current frame is a dynamic gesture detected state, based on a determination made for a previous frame, the dynamic gesture detector 113B is initially enabled for the current frame. However, if decision block 500 determines that the initial state of the finite state machine for the current frame is not a dynamic gesture detected state, the cursor detector 113A is initially enabled for the current frame.

Therefore, depending on the initial state of the finite state machine 115 in the current frame, either the cursor detector 113A or the dynamic gesture detector 113B is activated first for the current frame. If a dynamic gesture was detected in the previous frame, the finite state machine will initially be in the dynamic gesture detected state in the current frame, and the dynamic gesture detector is enabled first in the current frame. Otherwise, the cursor detector is enabled first in the current frame.

Assuming by way of example that the cursor detector 113A is initially enabled, decision block 412 indicates whether or not the cursor detector detects a cursor in the current frame. If a cursor is detected by the cursor detector for the current frame, cursor location and tracking block 302 is applied using a cursor gesture pattern ID provided by the cursor detector 113A. If a cursor is not detected by the cursor detector for the current frame, the finite state machine 115 enables the dynamic gesture detector 113B for the current frame.

If decision block 414 indicates that a dynamic gesture is detected by the dynamic gesture detector 113B for the current frame, dynamic gesture recognition block 304 is applied. If a dynamic gesture is not detected by the dynamic gesture detector for the current frame, and the finite state machine 115 is still in a dynamic gesture detected state from a previous frame, the finite state machine enables the cursor detector 113A for the current frame. Processing then continues through decision block 412 as previously described. If a dynamic gesture is not detected by the dynamic gesture detector, and if the decision block 502 indicates that the finite state machine is not in a dynamic gesture detected state, the finite state machine enables the static pose recognition module 114 for the current frame.

Accordingly, in the present embodiment, the finite state machine control is configured such that the static pose recognition module 114 is enabled for the current frame only if a cursor is not detected by the cursor detector 113A and a dynamic gesture is not detected by the dynamic gesture detector 113B. Again, other types of finite state machine control can be provided in other embodiments.

FIG. 6 illustrates the manner in which the state of the finite state machine 115 is updated in conjunction with completion of the recognition processing for the current frame. More particularly, in this exemplary state update module, the outputs of the cursor detector 113A, dynamic gesture detector 113B and static pose recognition module 114 are applied to a maximization element 600, the output of which is used to determine a new state 602 for the finite state machine.

The outputs of the respective cursor detector, dynamic gesture detector and static pose recognition module comprise the respective cursor gesture pattern ID, dynamic gesture pattern ID and static pose pattern ID if any such IDs were detected. If one or more of the cursor detector, dynamic gesture detector and static pose recognition module were not enabled under control of the finite state machine in the current frame, or if enabled in the current frame did not result in an affirmative detection decision, its output is a zero as indicated in the figure.

It is assumed that the finite state machine control in the present embodiment ensures that only one of the cursor detector, dynamic gesture detector and static pose recognition module will generate an affirmative detection decision in the current frame.

Accordingly, the maximization element 600 will determine the new state 602 for the finite state machine as one of the cursor detected state, the dynamic gesture detected state or the static pose recognition state, based on which of the corresponding pattern ID outputs was non-zero for the current frame. This new state 602 becomes the final state for the finite state machine in the current frame, and as indicated previously also serves as the initial state of the finite state machine for the next frame.

The particular types and arrangements of processing blocks shown in the embodiments of FIGS. 2 through 6 are exemplary only, and additional or alternative blocks can be used in other embodiments. For example, blocks illustratively shown as being executed serially in the figures can be performed at least in part in parallel with one or more other blocks or in other pipelined configurations in other embodiments.

The illustrative embodiments provide significantly improved gesture recognition performance relative to conventional arrangements. For example, these embodiments can support higher frame rates than would otherwise be possible by substantially reducing the amount of processing time required when cursors or dynamic gestures are detected. Accordingly, the GR system performance is accelerated while ensuring high precision in the recognition process. The disclosed techniques can be applied to a wide range of different GR systems, using depth, grayscale, color, infrared and other types of imagers which support a variable frame rate, as well as imagers which do not support a variable frame rate, and in both short range applications using hand gestures and long range application using arm or body gestures.

Different portions of the GR system 110 can be implemented in software, hardware, firmware or various combinations thereof. For example, software utilizing hardware accelerators may be used for some processing blocks while other blocks are implemented using combinations of hardware and firmware.

At least portions of the GR-based output 112 of GR system 110 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising:
configuring a gesture recognition system to include a cursor detector, a dynamic gesture detector and a static pose recognition module; and
providing a finite state machine to control selective enabling of the cursor detector, the dynamic gesture detector and the static pose recognition module;
wherein the configuring and providing are implemented in an image processor comprising a processor coupled to a memory.

2. The method of claim 1 wherein the finite state machine has a plurality of states including:
a cursor detected state in which cursor location and tracking are applied responsive to detection of a cursor in a current frame;
a dynamic gesture detected state in which dynamic gesture recognition is applied responsive to detection of a dynamic gesture in the current frame; and
a static pose recognition state in which static pose recognition is applied responsive to failure to detect a cursor or a dynamic gesture in the current frame.

3. The method of claim 1 wherein a final state of the finite state machine for a current frame is determined as a function of outputs of respective ones of the cursor detector, dynamic gesture detector and static pose recognition module for the current frame.

4. The method of claim 3 wherein the final state of the finite state machine for the current frame is utilized as an initial state of the finite state machine for a subsequent frame.

5. The method of claim 3 wherein an initial state of the finite state machine for the current frame is given by a final state of the finite state machine for a previous frame.

6. The method of claim 1 wherein the finite state machine is configured such that only one of the cursor detector, dynamic gesture detector and static pose recognition module is enabled at a time.

7. The method of claim 1 wherein the cursor detector and the dynamic gesture detector operate at a higher frame rate than the static pose recognition module.

8. The method of claim 1 wherein the finite state machine is configured to adjust a frame rate of operation of the gesture recognition system responsive to outputs of the cursor detector and the dynamic gesture detector.

9. The method of claim 1 wherein if an initial state of the finite state machine for a current frame is a dynamic gesture detected state, the dynamic gesture detector is initially enabled for the current frame.

10. The method of claim 9 wherein if a dynamic gesture is detected by the dynamic gesture detector for the current frame, dynamic gesture recognition is applied, and if a dynamic gesture is not detected by the dynamic gesture detector for the current frame, the finite state machine enables the cursor detector for the current frame.

11. The method of claim 10 wherein if a dynamic gesture is not detected by the dynamic gesture detector and a cursor is not detected by the cursor detector, the finite state machine enables the static pose recognition module for the current frame.

12. The method of claim 1 wherein if an initial state of the finite state machine for a current frame is not a dynamic gesture detected state, the cursor detector is initially enabled for the current frame.

13. The method of claim 12 wherein if a cursor is detected by the cursor detector for the current frame, cursor location and tracking is applied, and if a cursor is not detected by the cursor detector for the current frame, the finite state machine enables the dynamic gesture detector for the current frame.

14. The method of claim 13 wherein if a dynamic gesture is not detected by the dynamic gesture detector and a cursor is not detected by the cursor detector, the finite state machine enables the static pose recognition module for the current frame.

15. A non-transitory computer-readable storage medium having computer program code embodied therein, wherein the computer program code when executed in the image processor causes the image processor to perform the method of claim 1.

16. An apparatus comprising:
an image processor comprising image processing circuitry and an associated memory;
wherein the image processor is configured to implement a gesture recognition system utilizing the image processing circuitry and the memory, the gesture recognition system comprising:
a cursor detector;
a dynamic gesture detector;
a static pose recognition module; and
a finite state machine configured to control selective enabling of the cursor detector, the dynamic gesture detector and the static pose recognition module.

17. The apparatus of claim 16 wherein the finite state machine has a plurality of states including:
a cursor detected state in which cursor location and tracking are applied responsive to detection of a cursor in a current frame;
a dynamic gesture detected state in which dynamic gesture recognition is applied responsive to detection of a dynamic gesture in the current frame; and
a static pose recognition state in which static pose recognition is applied responsive to failure to detect a cursor or a dynamic gesture in the current frame.

18. The apparatus of claim 16 wherein the finite state machine is configured such that only one of the cursor detector, dynamic gesture detector and static pose recognition module is enabled at a time.

19. An integrated circuit comprising the apparatus of claim 16.

20. An image processing system comprising the apparatus of claim 16.
